(19) United States
(12) Patent Application Publication
(10) Pub. No.: US 2002/0126251 A1
(43) Pub. Date: Sep. 12, 2002

(54) Method for manufacturing liquid crystal display device

(76) Inventor: Kyeong Jin Kim, Kumi-shi (KR)

Correspondence Address: Song K. Jung, LONG ALDRIDGE & NORMAN LLP, Suite 600, 701 Pennsylvania Avenue N.W., Washington, DC, 20004, US

(21) Appl. No.: 10/015,701

(22) Filed: Dec. 17, 2001

(30) Foreign Application Priority Data
Dec. 15, 2000 (KR) 2000-77084

(51) Int. Cl. G02F 1/1339

(52) U.S. Cl. 349/190

(57) ABSTRACT

A method of forming a liquid crystal display device includes forming a plurality of thin film transistors and pixel electrodes on a first substrate; forming a dielectric frame and a sealant on a second substrate, the height of the dielectric frame being different from the height of the sealant; dispensing liquid crystal on the first substrate; and attaching the first and second substrates to each other.

This application claims the benefit of Korean Patent Application No. P2000-77084 filed on Dec. 15, 2000, which is hereby incorporated by reference as if fully set forth herein.

### BACKGROUND OF THE INVENTION

1. Field of the Invention

The present invention relates to a display device, and more particularly, to a method of manufacturing a liquid crystal display (LCD) device in which an image is displayed based on an electro-optical characteristic of a liquid crystal.

2. Discussion of the Related Art

With the rapid development of information communication fields, the importance of the display industry.

A cathode ray tube (CRT) can display various colors and has excellent brightness. In this respect, the CRT has been the main display device in the past. However, with the demand for a portable display device having a large screen and high resolution, it is necessary to develop a flat panel display to replace the CRT, which is heavy and bulky. Such flat panel displays are widely used in monitors for computers and even applications in spacecraft and aircraft.

Examples of the flat panel display include an LCD, an electroluminescent display (ELD), a field emission display (FED), and a plasma display panel (PDP). An ideal flat panel display has the following characteristics: light weight, high luminance, high efficiency, high resolution, fast response time, low driving voltage, low power consumption, low cost, and natural color display.

An LCD device that is thin and small in size has been recently developed to sufficiently serve as a flat panel display device. Thus, the demand for such LCD device has been increasing.

An LCD device and a method of manufacturing the LCD device will now be described with reference to the accompanying drawings.

FIGS. 1A and 1B are perspective views showing an LCD device, in which FIG. 1A shows an alignment state of liquid crystal molecules when no voltage is applied and FIG. 2B shows an alignment state of liquid crystal molecules when a voltage is applied.

As shown in FIGS. 1A and 1B, the LCD device includes first and second substrates 11 and 11a, dielectric frames 13 respectively formed on the first and second substrates 11 and 11a, and liquid crystal molecules 15 sealed between the first and second substrates 11 and 11a.

In the LCD device of FIG. 1A, the liquid crystal molecules 15 are aligned in a vertical direction when no voltage is applied. As shown in FIG. 1B, the liquid crystal molecules 15 are aligned in four different directions when a voltage is applied.

On the first substrate 11, although not shown, a plurality of data and gate lines are formed in first and second directions to define a plurality of pixel regions. A thin film transistor (TFT) is formed in each pixel region and includes a gate electrode, a gate insulating film, a semiconductor layer, an ohmic contact layer, and source and drain electrodes. A passivation film is formed over the whole first substrate. A pixel electrode is formed on the passivation film to connect with the drain electrode. On the second substrate 11a, a color filter layer is formed to display color, and a common electrode is formed on the color filter layer. In some instances, the color filter may be formed on the first substrate 11.

In the aforementioned LCD device, after the first and second substrates are formed, a sealant is printed on the second substrate. Spacers are distributed on the first substrate having the TFTs, to maintain a cell gap between the first and second substrate. Subsequently, the first and second substrates are attached to each other and then the liquid crystal is injected between them through a liquid crystal injection hole.

The liquid crystal is injected between the first and second substrates within a vacuum chamber using a pressure difference. If the liquid crystal panel on which the sealant is printed is located within the vacuum chamber and pressure is gradually reduced, an inner portion of the liquid crystal panel takes on a low pressure state close to vacuum. While the inner portion of the liquid crystal panel is maintained at a low pressure state, the liquid crystal injection hole comes in contact with the liquid crystal. Then, if air is introduced into the chamber, external pressure of the liquid crystal panel gradually becomes high. For this reason, the pressure difference occurs between the inner and outer portions of the panel and the liquid crystal is injected into the panel under the vacuum state. As a result, a liquid crystal layer is formed between the first and second substrates.

However, this method of manufacturing an LCD device has several problems. Although the dielectric frames serve to drive the liquid crystal molecules in various directions and divide the pixels, it is difficult to smoothly inject the liquid crystal by vacuum injection due to the dielectric frames. For this reason, additional time is needed for injecting the liquid crystal. This increases the turn around time (TAT), thereby reducing productivity.

### SUMMARY OF THE INVENTION

Accordingly, the present invention is directed to a method for manufacturing an LCD device that substantially obviates one or more of the problems due to limitations and disadvantages of the related art.

An advantage of the present invention is to provide a method of manufacturing an LCD device in which liquid crystal is uniformly distributed by a liquid crystal dispensing method under a structure having a dielectric frame.

Another advantage of the present invention is to provide a method of manufacturing an LCD device, in which injection time of a liquid crystal is reduced to improve productivity.

Additional features and advantages of the invention will be set forth in the description which follows, and in part will be apparent from the description, or may be learned by practice of the invention. The objectives and other advantages of the invention will be realized and attained by the scheme particularly pointed out in the written description and claims hereof as well as the appended drawings.

To achieve these and other advantages and in accordance with the purpose of the present invention, as embodied and broadly described, a method for manufacturing an LCD device according to the present invention includes forming a plurality of thin film transistors and pixel electrodes on a first substrate, forming a dielectric frame and a sealant on a second substrate, the height of the dielectric frame being different from the height of the sealant, dispensing liquid crystal on the first substrate, and attaching the first and second substrates to each other.

In the preferred embodiment of the present invention, the dielectric frame is formed to drive liquid crystal molecules in various directions, and a step difference between the dielectric frame and the sealant is obtained so that the dielectric frame does not hinder the liquid crystal from being injected. Also, the liquid crystal is formed not by a vacuum injection method but by a dispensing method which does not require a liquid crystal injection hole.

It is to be understood that both the foregoing general description and the following detailed description are exemplary and explanatory and are intended to provide further explanation of the invention as claimed.

### BRIEF DESCRIPTION OF THE DRAWINGS

These and other objects of the invention will be apparent from the following detailed description of the embodiments of the present invention with reference to the accompanying drawings.

In the drawings:

FIG. 1A shows an alignment state of liquid crystal molecules when no voltage is applied;

FIG. 1B shows an alignment state of liquid crystal molecules when a voltage is applied;

FIGS. 2A to 2E are sectional views illustrating a method for manufacturing an LCD device according to the present invention;

FIG. 3A shows L-shaped TFTs;

FIG. 3B shows U-shaped TFTs;

FIG. 4 shows liquid crystals dispensed on the substrate;

FIG. 5 is a sectional view of a thin film transistor and pixel area;

FIG. 6 is a section view of a thin film transistor and pixel area having a slit;

FIG. 7 shows an alternative embodiment of FIG. 6; and

FIG. 8 shows an alternative embodiment of FIG. 6.

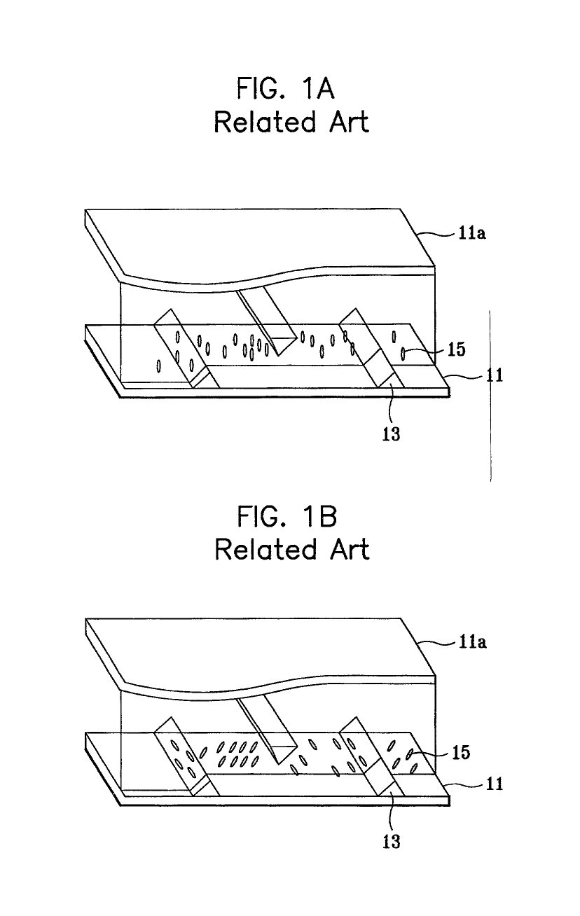

### DETAILED DESCRIPTION OF THE PREFERRED EMBODIMENTS

Reference will now be made in detail to the preferred embodiments of the present invention, examples of which are illustrated in the accompanying drawings.

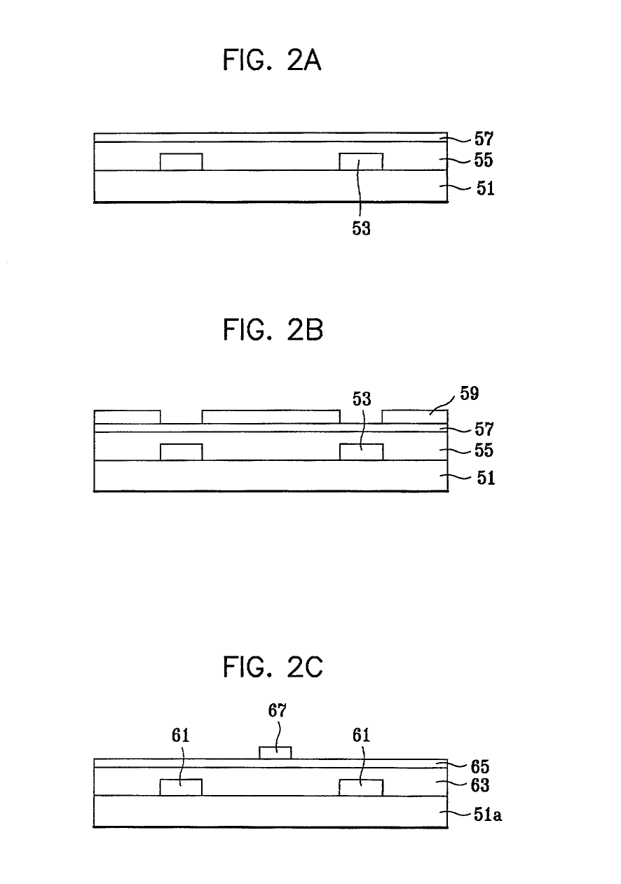

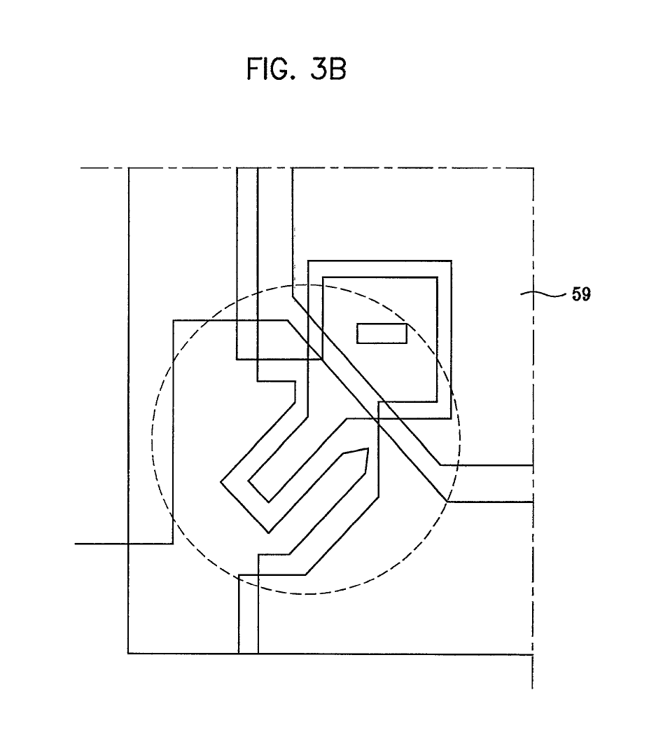

FIGS. 2A to 2E are sectional views illustrating a method for manufacturing an LCD device according to the present invention. FIGS. 2A to 2E show the TFT panel. FIG. 5 shows a thin film transistor (TFT) and a pixel area corresponding to the TFT.

As shown in FIG. 2A and FIG. 5, a metal such as Al, Mo, Cr, Ta or Al alloy is formed on a first substrate 51 by a sputtering process, for example, and then patterned to form gate lines 53 and a gate electrode 53 of a TFT. An insulating layer such as SiNₓ or SiOₓ is deposited on an entire surface of the first substrate 51 including the gate lines 53 and the gate electrode 53 to form a gate insulating film 55. A semiconductor layer 56 which will be used as a channel of the TFT is formed on the gate insulating film 55 on the gate electrode.

Afterwards, a metal such as Al, Mo, Cr, Ta or Al alloy is formed on the entire surface of the first substrate 51 including the semiconductor layer 56 and then patterned to form data lines 54 in a direction crossing the gate lines 53. Also, source and drain electrodes 54a and 54b of the TFT are formed on the semiconductor layer 56. An ohmic contact layer 56a is formed between the source and drain electrodes 54a and 54b and the semiconductor 56 layer.

A passivation film 57 is formed on the entire surface including the source and drain electrodes 54a and 54b. As shown in FIG. 5, a contact hole is formed in the passivation film 57 to expose a portion of the drain electrode 54b. A pixel electrode 59 made of indium-tin-oxide (ITO), for example, is formed on the passivation film 57 and contacts the drain electrode 54b through the contact hole.

FIG. 2A shows a TFT panel having gate lines 53 on a substrate 51, a gate insulating layer 55 on the gate lines and the substrate 53, and a passivation layer 57. FIG. 2B shows the ITO layer 59 having a hole, for example.

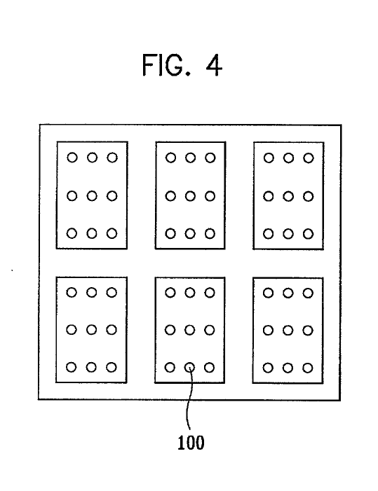

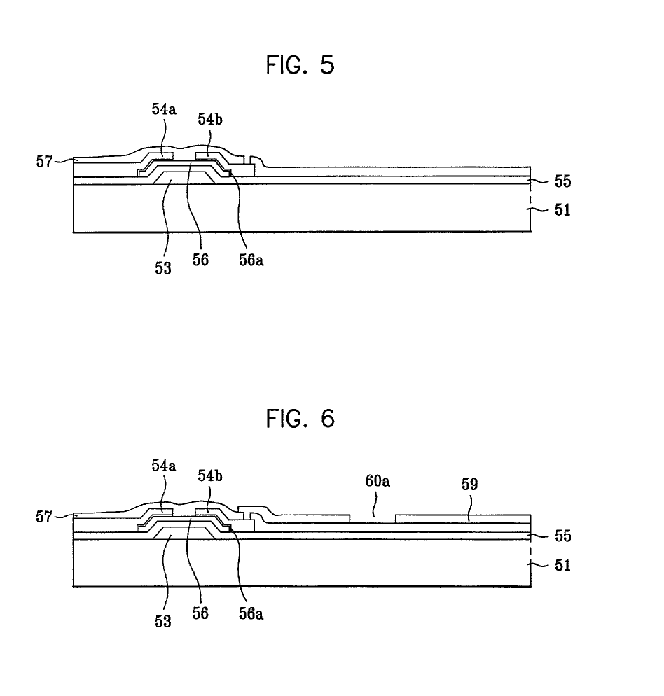

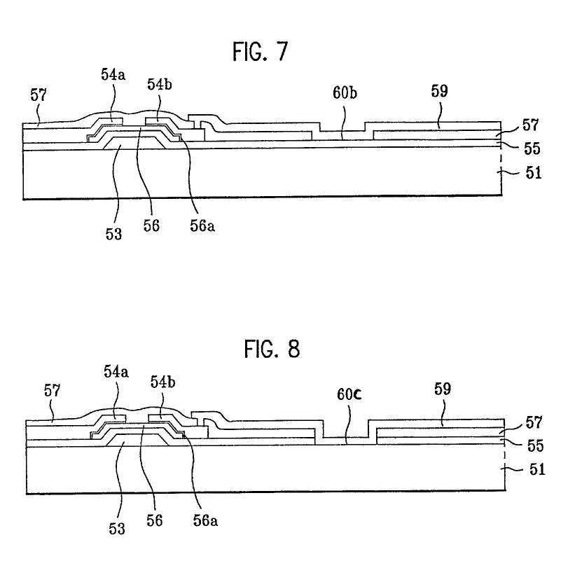

Referring to FIGS. 6-8, an electric field inducing window may be formed in the pixel electrode 59 (60a), the passivation film 57 (60b) and/or the gate insulating film 55 (60c). The electric field inducing window may have a slit or hole shape. For example, as shown in FIG. 6, the slit 60a is formed in the pixel electrode 59. FIG. 7 shows a hole 60b formed in the passivation film 57. FIG. 8 shows a hole 60b formed in the passivation film 57 and the gate insulating film 55.

As shown in FIG. 2C, a black matrix layer 61 is formed on the second substrate 51 a to prevent light from being transmitted to a region other than the pixel electrode 59 of the TFT substrate. An R, G, B color filter layer 63 is formed on the second substrate 51a, including the black matrix 61, by any one of a dyeing method, a dispersion method, an electrodeposition method, and a printing method. A transparent electrode material such as indium tin oxide (ITO) is formed on the entire surface including the color filter pattern 63 so that a common electrode 65 is formed to apply a voltage to a liquid crystal layer.

Afterwards, a material having a small dielectric constant such as photoacrylate, polyimide, or benzocyclobutene (BCB) is formed on the common electrode 65. A dielectric frame 67 is formed by a photolithography process to cross the pixel regions in a zig-zag shape, for example. Thus, a color filter substrate is completed.

The dielectric frame 67 has various shapes such as “+”, “×”, and “−”. The dielectric frame 67 divides a single pixel into multiple subpixels and at the same time drives the liquid crystal in various directions by inducing and distorting an electric field applied to the liquid crystal layer 100, thereby obtaining a multi-domain effect. This means that a dielectric energy by the distorted electric field places a liquid crystal director at a desired position when a voltage is applied to the LCD device. Thus, a vertical alignment mode liquid crystal display system is achieved.

A phase difference film may be further formed on the first substrate 51 or the second substrate 51a by expanding a polymer thereon. The phase difference film includes a negative uniaxial film having one optical axis and acts to compensate for a viewing angle of a user. Therefore, the viewing angle in the left and right directions can be effectively compensated and a wide viewing angle may be achieved.

In addition to the negative uniaxial film, a negative biaxial film having two optical axes may be formed as the phase difference film.

An alignment film is formed on the first substrate 51 and/or the second substrate 51a. For the alignment material of the alignment film, polyamide or polyimide based compound, polyvinyalcohol(PVA), polyamic acid, or SiO₂ can be used. If a rubbing method is used for the alignment direction, a material suitable for the rubbing method may be used as the alignment material of the alignment film. If a photoalignment method is used, a photo-alignment film of a material such as polyvinylcinnamate(PVCN), polysiloxanecinnamate(PSCN), or cellulosecinnamate(CelCN) based compound may be used. Other suitable materials for photo-alignment may be used as the alignment film.

For photo-alignment, light is irradiated on the photo-alignment film at least one time to determine a pretilt angle and alignment direction or pretilt direction of the director of the liquid crystal molecules at the same time, thereby obtaining a stable alignment of the liquid crystal. Suitable light for photo-alignment is used such as light in an ultraviolet ray region. Polarized light, unpolarized light, linearly polarized light or partially polarized light may be used for the photo-alignment.

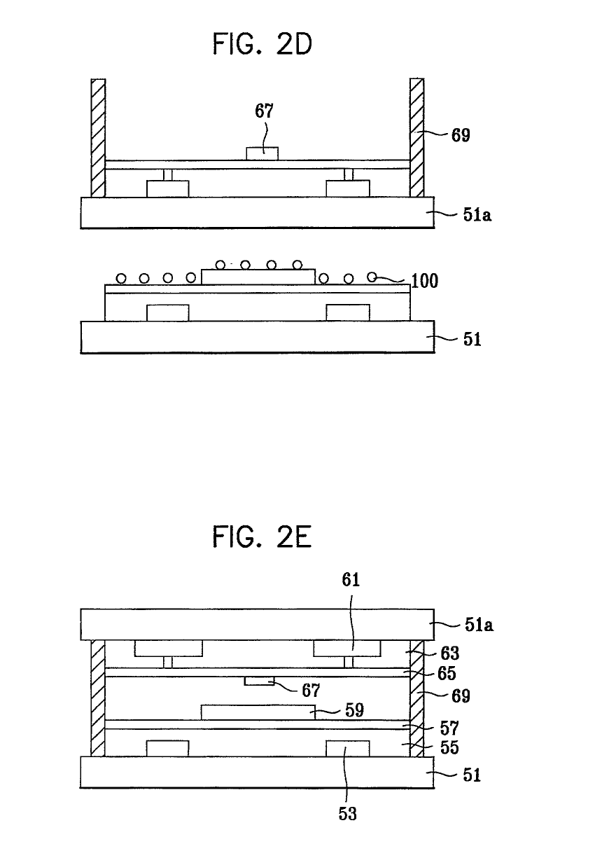

The thin film transistor (TFT) may be formed in an “L” or “U” shape, as shown in FIG. 3A and FIG. 3B, respectively. If the TFT is formed in an “L” or “U” shape, it is possible to improve the aperture ratio and reduce parasitic capacitance between the gate line and the drain electrode.

Subsequently, as shown in FIG. 2D, an ultraviolet ray hardening sealant or a sealant 69 that can be hardened by heat and ultraviolet ray irradiation is formed in a sealing region on the second substrate 51a. The liquid crystal layer 100 is formed on the first substrate 51 by a dispensing method. The sealant may be a double sealant. After the liquid crystal layer is formed, the first and second substrates are attached to each other, as shown in FIG. 2E.

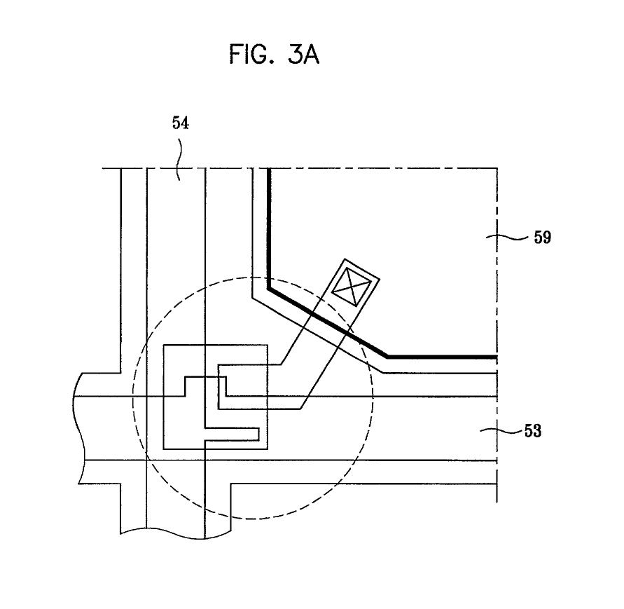

Before the first substrate 51 and the second substrate 51a are attached to each other the liquid crystal is distributed on the first substrate 51 with an appropriate amount using a dispenser, as shown in FIG. 4. A primary cell gap is formed under vacuum state and is exposed to atmospheric pressure. A secondary cell gap is formed by the amount of the liquid crystal and the pressure difference between the interior of the panel and the atmosphere. The hardening of the sealant is completed by exposure to UV ray preferably under no pressure.

At this time, the thickness of the sealant 69 is controlled to sufficiently obtain a step difference between the sealant 69 and the dielectric frame 67. The suitable step difference between the sealant 69 and the dielectric frame 67 allows adequate movement of the liquid crystal in the liquid crystal layer.

The height of the sealant is higher than the height of the dielectric frame. Preferably, the difference in the height is more than 1 μm. If the height of the sealant becomes lower, the height of the dielectric frame becomes lower. The height of the sealant may be proportional to the height of the dielectric frame. The dielectric frame should have a minimum height to efficiently provide electric field distortion. Table I shows a mutual relationship between the height of the sealant and the height of the dielectric frame.

TABLE I

| Height of | Height of dielectric | |
|---|---|---|
| sealant (um) | frame (um) | Effect |
| 5˜8 | 1 | Facilitate formation of liquid |
| | | crystal |
| | 1.5 | Facilitate formation of liquid |
| | | crystal |
| | 2 | Facilitate formation of liquid |
| | | crystal |
| 4 | 1 | Facilitate formation of liquid |
| | | crystal |
| | 1.5 | Facilitate formation of liquid |
| | | crystal |
| | 2 | Facilitate formation of liquid |
| | | crystal |
| 3 | 1 | Facilitate formation of liquid |
| | | crystal |
| | 1.5 | Facilitate formation of liquid |
| | | crystal |
| | 2 | Generate bubble in liquid crystal |
| 2 | 1 | Facilitate formation of liquid |
| | | crystal |
| | 1.5 | Generate bubble in liquid crystal |
| | 2 | Generate bubble in liquid crystal |
| | | and poor cell gap |

The liquid crystal may have a positive dielectric anisotropy or a negative dielectric anisotropy. The liquid crystal may include a chiral dopant.

As described above, the method for manufacturing an LCD device according to the present invention has at least the following advantages.

Since the liquid crystal layer is formed by the dispensing method, the time required to form the liquid crystal layer can be reduced considerably. The step difference between the sealant and the dielectric frame is obtained to uniformly distribute the liquid crystal on the substrate by the dispensing method. This prevents non-uniform distribution of the liquid crystal, which deteriortates picture quality.

It will be apparent to those skilled in the art that various modifications and variation can be made in the present invention without departing from the split or scope of the invention. Thus, it is intended that the present invention cover the modifications and variations of this invention provided they come within the scope of the appended claims and their equivalents.

What is claimed is:

1. A method of forming a liquid crystal display device comprising:
forming a thin film transistor and a pixel electrode on a first substrate;
forming a dielectric frame having a first height and a sealant having a second height on a second substrate, the first height of the dielectric frame being different from the second height of the sealant;
dispensing liquid crystal on the first substrate; and
attaching the first and second substrates to each other.

2. The method of claim 1, wherein the sealant includes a material hardened by ultraviolet ray.

3. The method of claim 1, wherein the sealant includes a double sealant structure.

4. The method of claim 1, further comprising forming an electric field inducing window in the pixel electrode.

5. The method of claim 4, wherein the electric field inducing window has a slit shape or a hole shape.

6. The method of claim 1, wherein forming the thin film transistor includes:
forming a gate electrode on the first substrate;
forming a gate insulating film on the first substrate;
forming a semiconductor layer on the gate insulating film; and
forming source and drain electrodes on the semiconductor layer.

7. The method of claim 1, wherein the thin film transistor is formed to have an L-shape.

8. The method of claim 1, wherein the thin film transistor is formed to have a U-shape.

9. The method of claim 1, wherein the dielectric frame drives the liquid crystal in various directions.

10. The method of claim 1, wherein the second height of the sealant is higher than the first height of the dielectric frame.

11. The method of claim 10, wherein a height difference between the sealant and the dielectric frame is more than 1 μm.

12. The method of claim 1, further comprising forming a common electrode on the second substrate.

13. The method of claim 12, wherein the dielectric frame is formed on the common electrode.

14. The method of claim 1, further comprising forming an alignment layer on at least one of the first and second substrates.

15. The method of claim 14, wherein the alignment layer is selected from the group consisting of polyimide, polyamide, polyvinyl alcohol, polyamic acid, and silicon oxide.

16. The method of claim 14, wherein the alignment layer is selected from the group consisting of polyvinylcinnamate, polysiloxanecinnamate, and cellulosecinnamate.

17. The method of claim 1, further comprising forming a phase difference film on at least one of the first and second substrates.

18. The method of claim 17, wherein the phase difference film includes a negative uniaxial film.

19. The method of claim 1, wherein the phase difference film includes a negative biaxial film.

20. The method of claim 1, wherein the first height is a range of 1-2 μm and the second height is in a range of 5-8 μm.

21. The method of claim 1, wherein the first height is a range of 1-2 μm and the second height is about 4 μm.

22. The method of claim 1, wherein the first height is a range of 1-1.5 μm and the second height is about 3 μm.

23. The method of claim 1, wherein the first height is about 1 μm and the second height is about 2 μm.

24. A method of forming a liquid crystal display device comprising:
forming a gate electrode on a first substrate;
forming a gate insulating film on the gate electrode and the first substrate;
forming a semiconductor layer on the gate insulating film;
forming source and drain electrodes on the semiconductor layer;
forming a pixel electrode contacting the drain electrode, the pixel electrode including an electric field inducing window;
forming a dielectric frame having a first height and a sealant having a second height on a second substrate, the first height of the dielectric frame being different from the second height of the sealant, the dielectric frame capable of causing an electric field distortion;
dispensing liquid crystal on the first substrate; and
attaching the first and second substrates to each other.

25. The method of claim 24, wherein the first height is a range of 1-2 μm and the second height is in a range of 5-8 μm.

26. The method of claim 24, wherein the first height is a range of 1-2 μm and the second height is about 4 μm.

27. The method of claim 24, wherein the first height is a range of 1-1.5 μm and the second height is about 3 μm.

28. The method of claim 24, wherein the first height is about 1 μm and the second height is about 2 μm.
